(19) United States
(12) Patent Application Publication
(10) Pub. No.: US 2016/0098080 A1
(43) Pub. Date: Apr. 7, 2016

(54) FINGER-TOUCH TRACKING SYSTEM

(71) Applicant: National Taiwan University, Taipei (TW)

(72) Inventors: Bing-Yu Chen, Taipei (TW); Li-wei Chan, Taipei (TW); Rong-Hao Liang, Taipei (TW); Mike Y. Chen, Taipei (TW); Kai-Yin Cheng, Taipei (TW); Ming-Chang Tsai, Taipei (TW); Chao-Huai Su, Taipei (TW); Wen-Huang Cheng, Taipei (TW)

(21) Appl. No.: 14/508,448

(22) Filed: Oct. 7, 2014

(51) Int. Cl. G06F 3/01; G06F 3/046

(52) U.S. Cl. CPC G06F 3/011; G06F 3/046

(57) ABSTRACT

A finger-touch tracking system is provided, including a magnet, a magnetic field sensing unit, and a computing unit. The magnet generates a magnetic field. The magnetic field sensing unit moves relative to the magnet, and has a substrate and a plurality of sensors disposed on the substrate. The sensors detect a magnetic flux density of the magnet, so as to generate a tracking signal reflecting a relative position of the magnet with respect to the magnetic field sensing unit. The computing unit receives the tracking signal via a network, and employs the received tracking signal as an input instruction upon the magnitude of the magnetic field.

### BACKGROUND DISCLOSURE

1. Technical Field Disclosure The present disclosure relates to finger-touch tracking systems, and, more particularly, to a private finger-touch tracking system providing high speed and accurate operation.

2. Description of Related Art

Mobile computing device is a trend in recent developments, and head-mounted display or glass-mounted display is a promising implementation for visual outputs of mobile computing device. The glass-mounted display (e.g., Google Glass) provides excellent privacy for displaying personal information, such that the user can operate the mobile computing device without worrying that the displayed information may be snooped by others around.

However, such visual output device for high privacy lacks a corresponding private manner for interaction input. Currently, voice input is commonly used for glass-mounted displays because it is expressive and effective. Sometimes, voice input can be problematic. For example, the voice input can be hardly recognized in noisy environments, and privacy issues may arise with its use in public spaces (e.g., password input). Similarly, gesture input suffers from privacy concerns because input actions are readily observable. Also, performing voice or gesture input in public spaces can be embarrassing, and thus causes a social acceptability issue.

In order to provide private input, subtle interactions based on implicit movements and generally considered socially acceptable such as unobservable muscle movement and foot gesture are proposed. However, the proposed methods generally suffer from limited input space.

The above-described deficiencies of today's interaction input method are merely intended to provide an overview of some of the problems of the conventional methods, and are not intended to be exhaustive. Other problems with conventional methods and corresponding benefits of the various non-limiting embodiments described herein may become further apparent upon review of the following description.

### SUMMARY OF THE DISCLOSURE

An embodiment according to the present disclosure provides a finger-touch tracking system, comprising a magnet that generates a magnetic field, a magnetic field sensing unit that moves relative to the magnet, and a computing unit. The magnetic field sensing unit comprises a substrate and a plurality of sensors disposed on the substrate. The sensors detect a magnetic flux density of the magnet to generate a tracking signal reflecting a relative position of the magnet with respect to the magnetic field sensing unit. The computing unit receives the tracking signal via a network, and employs the tracking signal as an input instruction.

From the above, the finger-touch tracking system according to the present invention allows the user to accurately control a cursor on a display through the relative movement between two fingers, thereby achieving excellent privacy while ensuring the social acceptability. Moreover, the finger-touch tracking system places no constraints on the fingertip, finger, and hand, and thus the native ability of fingers is not affected.

### BRIEF DESCRIPTION OF DRAWINGS

The present disclosure can be more fully understood by reading the following detailed description of the preferred embodiments, with reference made to the accompanying drawings, wherein:

FIG. 1 is a schematic structural diagram of a finger-touch tracking system according to the present invention;

FIGS. 2A-2C are schematic diagrams of a magnetic field sensing unit according to an embodiment of the present invention;

FIG. 3 illustrates the cooperation between the magnetic field sensing unit and a magnet according to an embodiment of the present invention;

FIG. 4 is a schematic diagram illustrating the operation of a finger-touch tracking system according to the present invention; and

FIG. 5 is a schematic diagram illustrating a calibration operation of a finger-touch tracking system according to the present invention.

### DETAILED DESCRIPTION OF THE DISCLOSURE

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It should be advised that the structure, ratio, and size as illustrated in this context are only used for the disclosure of this specification, provided for those in the art to understand and read, do not have substantial meaning technically. Any modification of the structure, change of the ratio relation, or adjustment of the size should be involved in the scope of the disclosure in this creation without influencing the producible efficacy and the achievable objective of this creation.

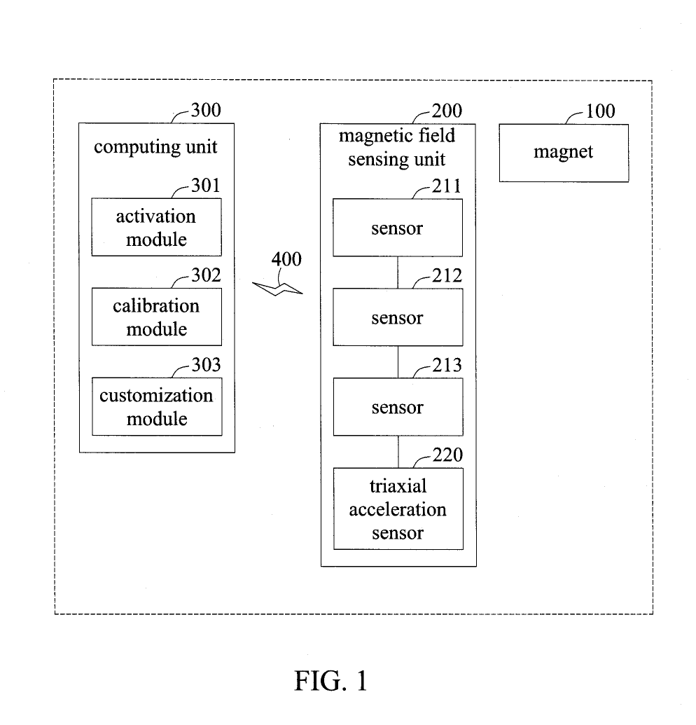

The present invention provides a finger-touch tracking system. As shown in FIG. 1, a structural diagram of a finger-touch tracking system of an embodiment according to the present invention is provided.

The finger-touch tracking system comprises a magnet 100, a magnetic field sensing unit 200, and a computing unit 300. In an embodiment, the computing unit 300 includes an activation module 301, a calibration module 302, and a customization module 303. In an embodiment, the magnetic field sensing unit 200 includes a plurality of sensors 211, 212 and 213, and a triaxial acceleration sensor 220. The sensors 211, 212 and 213 detect a magnetic flux density of the magnet 100, and generates a tracking signal reflecting a relative position of the magnet 100 with respect to the magnetic field sensing unit 200. Therefore, a relative movement between the magnet 100 and the magnetic filed sensing unit 200 can be detected. Once the tracking signal is generated, the computing unit 300 receives the tracking signal via a network 400, and employs the tracking signal as an input instruction when certain conditions are satisfied. The network 400 can be a wired or wireless network, and the computing unit 300 can be a computer, a smart phone, a wearable screen or the like.

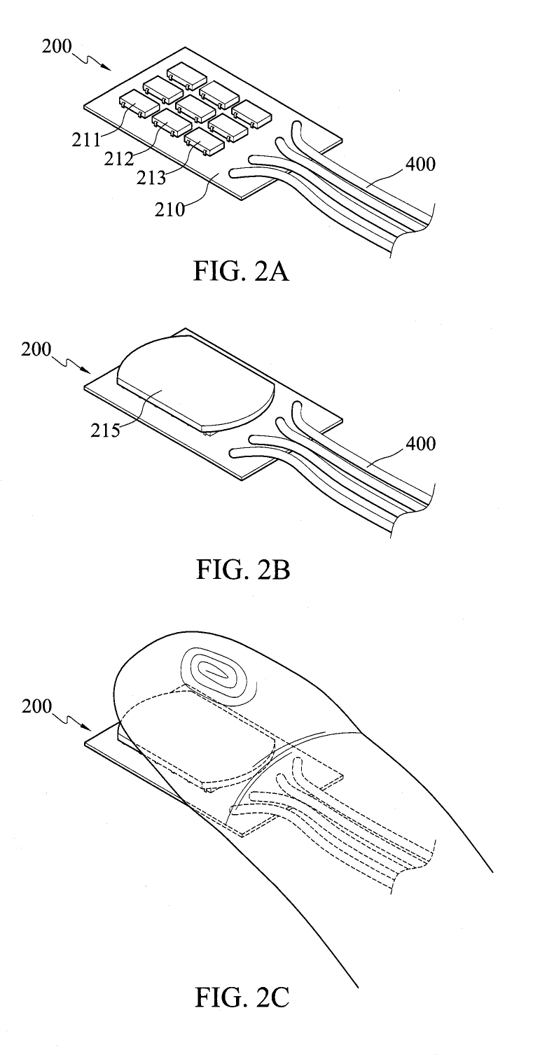

FIGS. 2A-2C illustrate an embodiment of the magnetic field sensing unit 200 according to the present invention. As shown in FIG. 2A, a substrate 210 is provided, and the sensors 211, 212 and 213 can be disposed on the substrate 210. In an embodiment, the sensors 211, 212 and 213 are 2D or 3D hall effect sensors and preferably are disposed on the substrate 210 and arranged in an array greater than 3×3. The array does not have to be a square array, and persons skilled in the art should appreciate that the magnetic field sensing unit 200 can be implemented as long as the size of the array is sufficiently large for detecting the relative movement between the magnet 100 and the magnetic filed sensing unit 200.

In FIG. 2B, a first fixing member 215 is connected to or glued onto the magnetic field sensing unit 200. In an embodiment, the first fixing member 215 can be obtained by using a 3D printer to craft a nail piece that suggests the curved surface of a natural nail. As shown in FIG. 2C, the first fixing member 215 is fixed on the nail of the user. Optionally, the first fixing member 215 is glued onto the nail of a user using twin adhesive tape. In an embodiment, the first fixing member 215 is shaped to suggest the curved surface of a forefinger, so as to be fixed on the nail of the forefinger of the user. However, it should be appreciated that the first fixing member 215 can also be shaped to suggest the curved surface of other finger, so as to be fixed on the nail thereof.

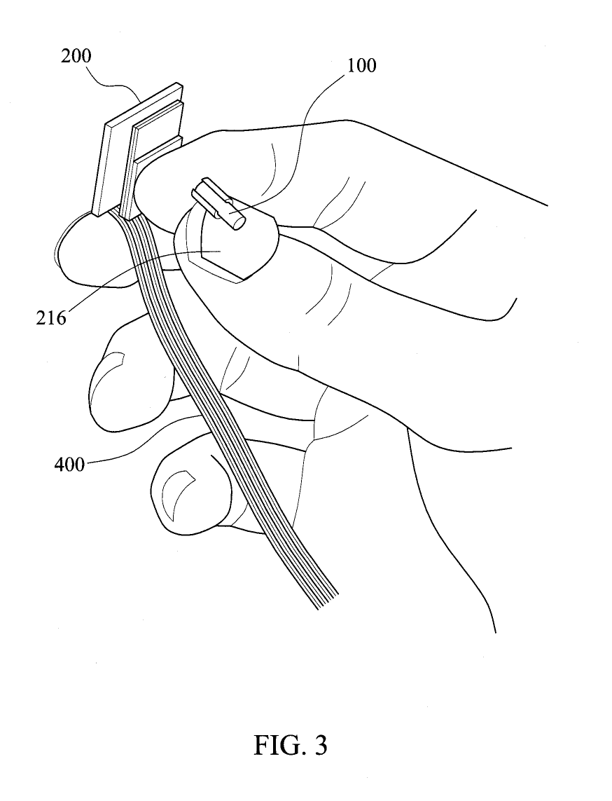

FIG. 3 illustrates the cooperation between the magnetic field sensing unit 200 and the magnet 100 according to an embodiment of the present invention. As shown in FIG. 3, the magnet 100 is connected to or glued onto a second fixing member 216, and the second fixing member 216 is fixed on the nail of another finger of the user. Similar to the first fixing member 215, the second fixing member 216 is shaped to suggest the curved surface of a thumb, so as to be fixed on the nail of the thumb of the user. However, it should be appreciated that the second fixing member 216 can also be shaped to suggest the curved surface of a finger other than that the first fixing member 215 is mounted on. Also, the orientation of the magnet 100 is fixed by the second fixing member 216. Preferably, the magnet 100 is placed such that the polar orientation of the magnet 100 is parallel with the normal of the magnetic field sensing unit 200 when the user places his thumb in the center of the tip of the forefinger. In order to adapt the bio-mechanism of the thumb and the forefinger, the magnet orientation 30 can be moved with 30 degrees clockwise. In an embodiment, the magnet 100 is a 3 mm-diameter times 8 mm-height cylindrical neodymium magnet, which allows effective sensing within 2.1 cm using the magnetic field sensing unit 200. Notably, this effective distance can be further extended with more sensitive magnetic field sensors, such as magnetometer.

Although the magnetic field sensing unit 200 can detect a hover state (e.g., when the magnet 100 mounted on the thumb is near the magnetic field sensing unit 200 mounted on the forefinger) based on the strength of the magnetic field, it is hard to determine when the thumb of the user contacts the forefinger tip. In order to detect such contact, the triaxial acceleration sensor 220 is disposed on the substrate 210 of the magnetic field sensing unit 200 to detect a vibration generated when the thumb touches the forefinger. In an embodiment, the triaxial acceleration sensor 220 may be replaced with a vibration sensor. Once the vibration is detected, a contact signal is generated to indicate a contact between the thumb and the forefinger, and can be transmitted to the computing unit 300 via the network 400.

In an embodiment, the tracking signal is formed by a plurality of coordinates, angles, distances, magnitude of magnetic field, or a combination thereof of the magnet 100 with respect to the magnetic field sensing unit 200. For example, in an embodiment of the magnetic field sensing unit 200 with an 3×3 array of sensors 211, 212 and 213, the lower left corner is set as the coordinate origin. When the magnet 100 moves relative to the magnetic field sensing unit 200, the angle therebetween may be inferred from the variations of magnetic flux density detected at respective sensors 211, 212 and 213. Therefore, the position of the magnet 100 can be approximated, such that the tracking signal reflects relative positions of the magnet 100 with respect to the magnetic field sensing unit 200.

The tracking signal can be employed as an input instruction of the computing unit 300 upon the determination made by the activation module 301 of the computing unit 300. In an embodiment, the determination is made based on the contact signal and the magnitude of magnetic field of the magnet 100 with respect to the magnetic field sensing unit 200. For example, when the magnitude of magnetic field of the magnet 100 with respect to the magnetic field sensing unit 200 is greater than a first threshold value and the contact signal is generated, the activation module 301 begins to employ the tracking signal as the input instruction. The first threshold value is selected to reflect that the magnet 100 is within the hover range. On the contrary, when the magnitude of magnetic field of the magnet 100 with respect to the magnetic field sensing unit 200 is less than a second threshold value, the activation module 301 stops employing the tracking signal as the input instruction. The second threshold value is selected to reflect that the magnet 100 is without the hover range.

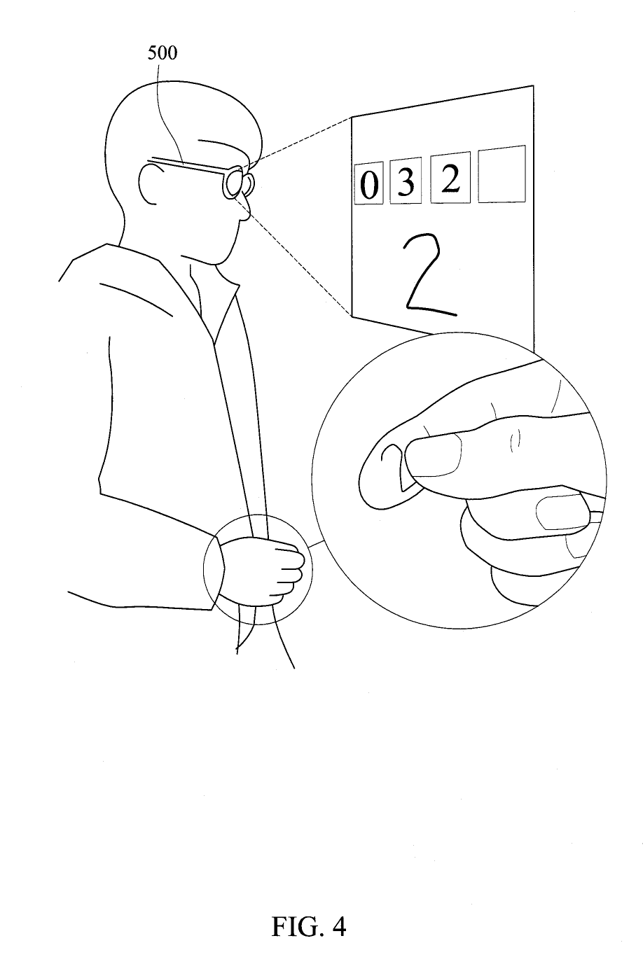

FIG. 4 illustrates a schematic view of the operation of the finger-touch tracking system according to the present invention. As illustrated, the user can enter passwords to a private glass-mounted display 500 with the finger-touch tracking system. For example, when the user draws a track “2” on his forefinger, the private glass-mounted display 500 shows a corresponding track “2” on the screen.

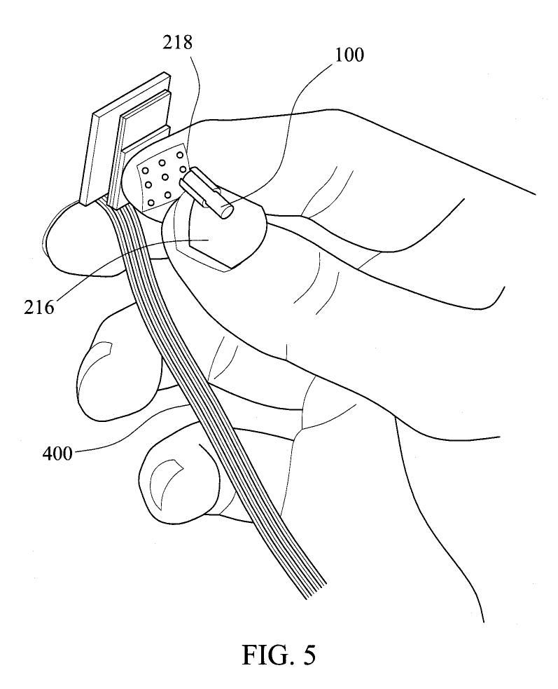

FIG. 5 illustrates a schematic view of a calibration operation of the finger-touch tracking system according to the present invention. In order to regulate the 2D positions of the tracking signal, the user may perform calibration to the magnetic field sensing unit 200 with the calibration module 302. For example, a 3×3 dot pattern 218 may be stuck on the forefinger mounted with the magnetic field sensing unit 200, such that the user can touch a plurality of calibration points of the calibration module with the thumb mounted with the magnet 100 to obtain a plurality of coordinates of the magnet 100 with respect to the magnetic field sensing unit 200. Since a homographic transformation can be determined by more than four pairwise correspondent points, the nine pairs of the correspondent points are then used to compute the homographic transformation for each of four sub-coordinates. Therefore, the nonlinear mapping between the array of sensors 211, 212, 213 and the coordinates of the magnet 100 is approximated, such that a space coordinate system of the tracking signal is built.

The customization module 303 of the computing unit 300 is utilized to define a portion of the tracking signals as the input instructions executable on the computing unit 300 for specific functions. For example, in the operation shown in FIG. 4, the user can also draw additional tracks, such as a clockwise circle, a counterclockwise circle, a slide from left to right, etc. The customization module 303 may be configured to define the track of a clockwise circle as an instruction of turning up the volume of the glass-mounted display 500. Similarly, other tracks can be determined as different instructions executable on the computing unit 300 by the customization module 303.

From above, the user may choose to use the finger-touch tracking system of the present invention to input instruction owing to privacy concerns and complete several operations, thereby bringing about several benefits such as private and socially acceptable, highly mobile, natural haptic feedback, and instant availability.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A finger-touch tracking system, comprising:
a magnet that generates a magnetic field;
a magnetic field sensing unit that moves relative to the magnet, and comprises a substrate and a plurality of sensors that are disposed on the substrate and detect a magnetic flux density of the magnet to generate a tracking signal reflecting a relative position of the magnet with respect to the magnetic field sensing unit; and
a computing unit that receives the tracking signal via a network as an input instruction.

2. The finger-touch tracking system of claim 1, further comprising a first fixing member connected to the magnetic field sensing unit, so as for the magnetic field sensing unit to be fixed on a nail of a first finger.

3. The finger-touch tracking system of claim 2, further comprising a second fixing member connected to the magnet, so as for the magnet to be fixed on a nail of a second finger.

4. The finger-touch tracking system of claim 3, further comprising a triaxial acceleration sensor or a vibration sensor disposed on the substrate for detecting a vibration generated by a contact between the first finger mounted with the magnetic filed sensing unit and the second finger mounted with the magnet and generating a contact signal.

5. The finger-touch tracking system of claim 4, wherein the tracking signal is formed by a plurality of coordinates, angles, distances, magnitude of magnetic field, or a combination thereof of the magnet with respect to the magnetic field sensing unit.

6. The finger-touch tracking system of claim 5, wherein the computing unit further comprises an activation module that determines whether the tracking signal is employed as the input instruction based on the contact signal and the magnitude of magnetic field of the magnet with respect to the magnetic field sensing unit.

7. The finger-touch tracking system of claim 6, wherein the activation module begins to employ the tracking signal as the input instruction when the magnitude of magnetic field of the magnet with respect to the magnetic field sensing unit is greater than a first threshold value and the contact signal is generated.

8. The finger-touch tracking system of claim 6, wherein the activation module stops employing the tracking signal as the input instruction when the magnitude of magnetic field of the magnet with respect to the magnetic field sensing unit is less than a second threshold value.

9. The finger-touch tracking system of claim 1, wherein the computing unit is a computer, a smart phone, or a wearable screen.

10. The finger-touch tracking system of claim 1, wherein the sensors are 2D or 3D hall effect sensors disposed on the substrate and arranged in an array greater than 3×3.

11. The finger-touch tracking system of claim 1, wherein the magnet is a cylindrical neodymium magnet.

12. The finger-touch tracking system of claim 1, wherein the network is a wired or wireless network.

13. The finger-touch tracking system of claim 1, wherein the computing unit further comprises a calibration module that allows a user to touch a plurality of calibration points of the calibration module, and obtains a plurality of coordinates of the magnet with respect to the magnetic field sensing unit when the user contacts the plurality of calibration points, so as to establish a space coordinate system of the tracking signal.

14. The finger-touch tracking system of claim 1, wherein the computing unit further comprises a customization module that defines a portion of the tracking signals as the input instructions executable on the computing unit for specific functions.
